(19) United States
(12) Patent Application Publication
(10) Pub. No.: US 2015/0266177 A1
(43) Pub. Date: Sep. 24, 2015

(54) MULTI-PURPOSE LOCKING PLIERS

(71) Applicant: Richard CONKLIN, Brackney, PA (US)

(72) Inventor: Richard CONKLIN, Brackney, PA (US)

(21) Appl. No.: 14/221,766

(22) Filed: Mar. 21, 2014

(51) Int. Cl. B25F 1/00; B25B 7/14; B25B 7/22; B25F 1/04

(52) U.S. Cl. CPC B25F 1/003; B25F 1/04; B25B 7/14; B25B 7/22

(57) ABSTRACT

An adjustable over-center locking pliers includes a stationary portion having a first jaw segment and a first handle segment. A movable portion has a second jaw segment and a second handle segment operatively connected to the stationary portion between the jaw segments and the handle segment

### BACKGROUND

The application relates generally to multi-purpose hand tools. The application relates more specifically to multi-purpose locking pliers.

Pliers, which typically include a pair of identical halves pivotably connected to each other, are useful in many applications. Further enhancements to the pliers have included an addition of a beyond center locking feature, hereinafter referred to as an over-center locking feature, permitting the application of a continuous compressive force to an object by the pliers, freeing an operator's hands for performing other tasks related to or independent of the object.

Unfortunately, incorporating adjustability into pliers having a conventional over-center locking feature results in a portion of the locking feature extending through the end of the handle of one end of the locking pliers. The space in the handle of the one end of the locking pliers is not otherwise usable, such as for securing tools therein.

Accordingly, there is an unmet need for an adjustable over-center locking pliers and a method for adjusting the pliers that does not suffer from the above-referenced drawbacks.

### SUMMARY

One embodiment of the present invention is directed to an adjustable over-center locking pliers including a stationary portion having a first jaw segment and a first handle segment. A movable portion having a second jaw segment and a second handle segment is operatively connected to the stationary portion between the jaw segments and the handle segments. At least one tool is movable between a first position and a second position. The stationary portion movably secures the at least one tool in the first position in the first handle segment of the stationary portion.

One embodiment of the present invention is directed to an adjustable over-center locking pliers including a stationary portion having a first jaw segment and a first handle segment. A movable portion having a second jaw segment and a second handle segment is operatively connected to the stationary portion between the jaw segments and the handle segments.

Another embodiment of the present invention is directed to a method for adjusting over-center locking pliers including providing a stationary portion having a first jaw segment and a first handle segment. The method further includes providing a movable portion having a second jaw segment and a second handle segment operatively connected to the stationary portion between the jaw segments and the handle segments, the pliers movable between an open position and a closed position. The method further includes manipulating the pliers to the open position. The method further includes while securing the pliers in one hand, the one hand resulting in adjustment of the manually adjustable operative connection.

### BRIEF DESCRIPTION OF THE FIGURES

FIG. 1 shows a front view of an exemplary embodiment of an adjustable over-center locking pliers.

FIG. 2 shows a back view opposite the front view of FIG. 1 of the adjustable over-center locking pliers.

FIG. 3 shows a front view of a disassembled exemplary embodiment of an adjustable over-center locking pliers.

FIG. 4 shows a side view of a disassembled portion of an exemplary embodiment of an adjustable over-center locking pliers.

FIG. 5 is a cross section taken along line 5-5 of FIG. 4 of an exemplary handle segment of an adjustable over-center locking pliers.

FIG. 6 is a cross section taken along line 5-5 of FIG. 4 of an exemplary handle segment of an adjustable over-center locking pliers.

FIGS. 7 and 8 show front views of exemplary tools usable with an adjustable over-center locking pliers.

FIGS. 9A, 9B and 9C show orthogonal views of an exemplary tool usable with an adjustable over-center locking pliers.

FIGS. 10, 11 and 12 show front views of exemplary tools usable with an adjustable over-center locking pliers.

FIGS. 13A and 13B show different exploded views of an exemplary adjustable linkage usable with an adjustable over-center locking pliers.

FIG. 14 shows an exemplary adjustable over-center locking pliers in an open position supported by a hand of an operator.

FIG. 14A shows an exemplary arrangement for adjusting the adjustable over-center locking pliers.

FIG. 15 shows an exemplary adjustable over-center locking pliers in a closed position secured by a hand of an operator.

### DETAILED DESCRIPTION OF EXEMPLARY EMBODIMENTS

Exemplary embodiments are directed to apparatus and method usable for an adjustable over-center locking pliers. The pliers include a stationary portion having a first jaw segment and a first handle segment. A movable portion having a second jaw segment and a second handle segment is operatively connected to the stationary portion between the jaw segments and the handle segments, as will be discussed in further detail below. The compact arrangement and ease of adjustment of the operative connection region or operative connection that is positioned between the jaw segments and the handle segments of the stationary portion and the movable portion provide advantages for use in multiple applications, including, but not limited to fishing, such as fly fishing and electrical wiring.

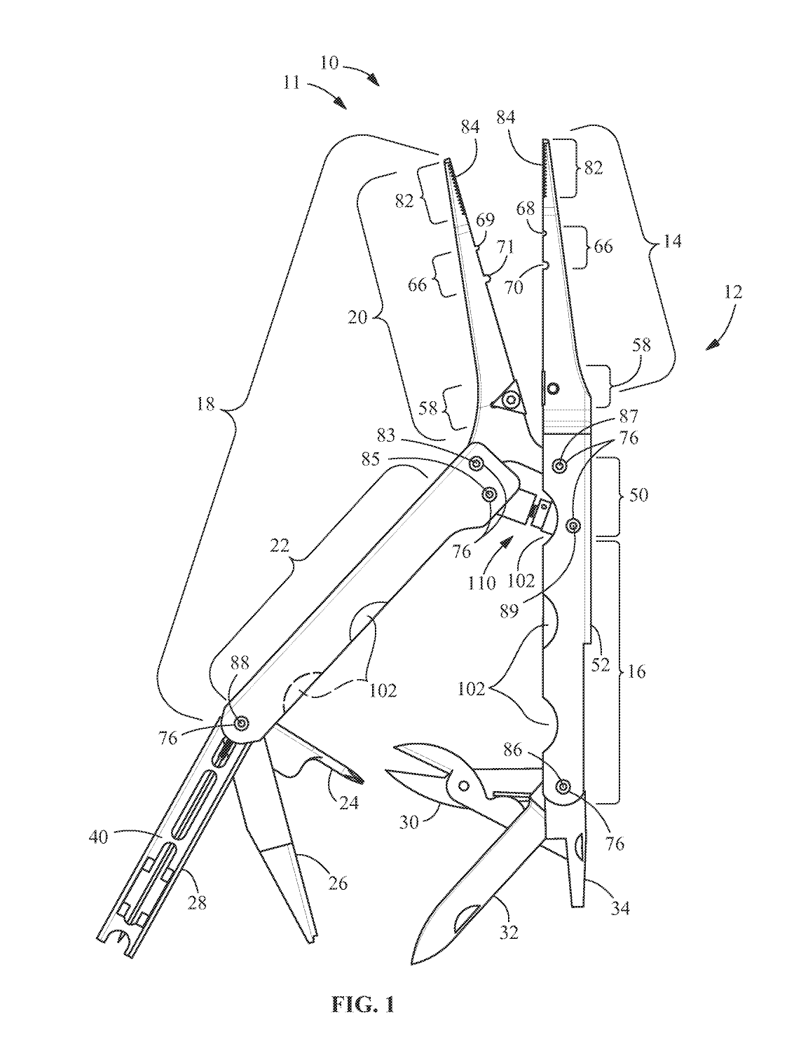

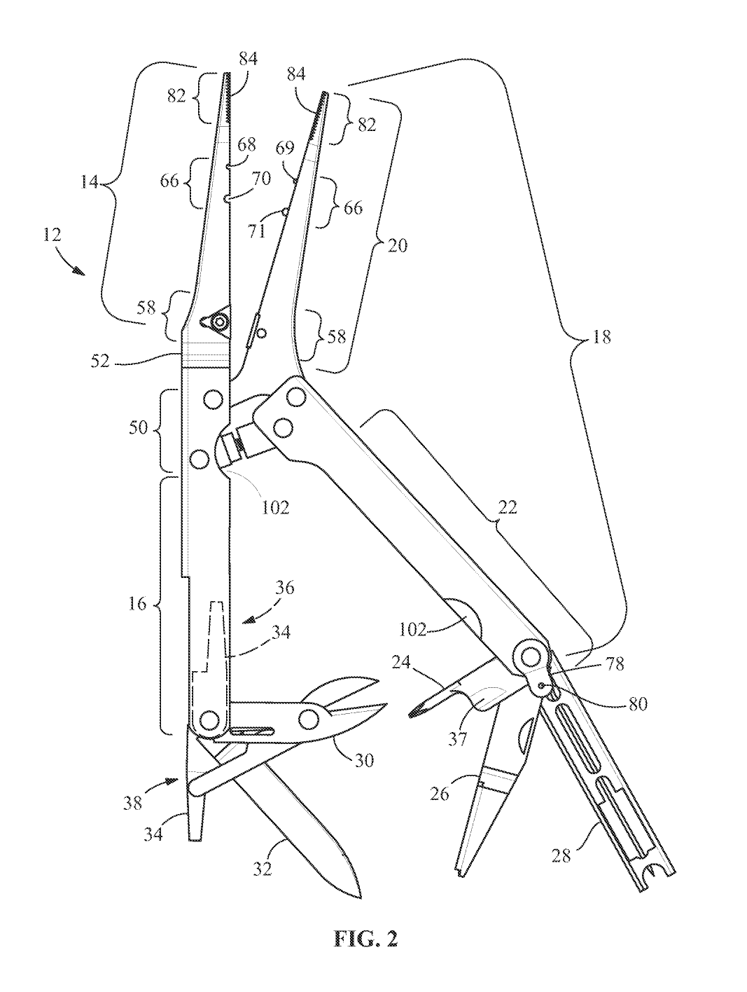

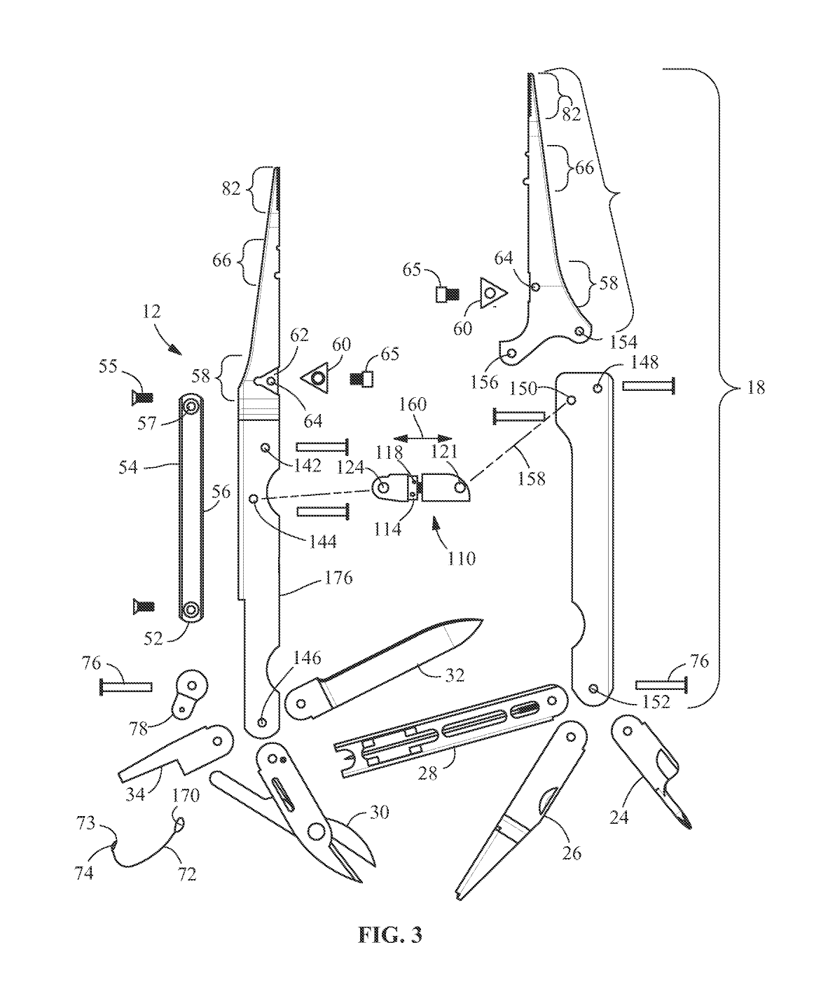

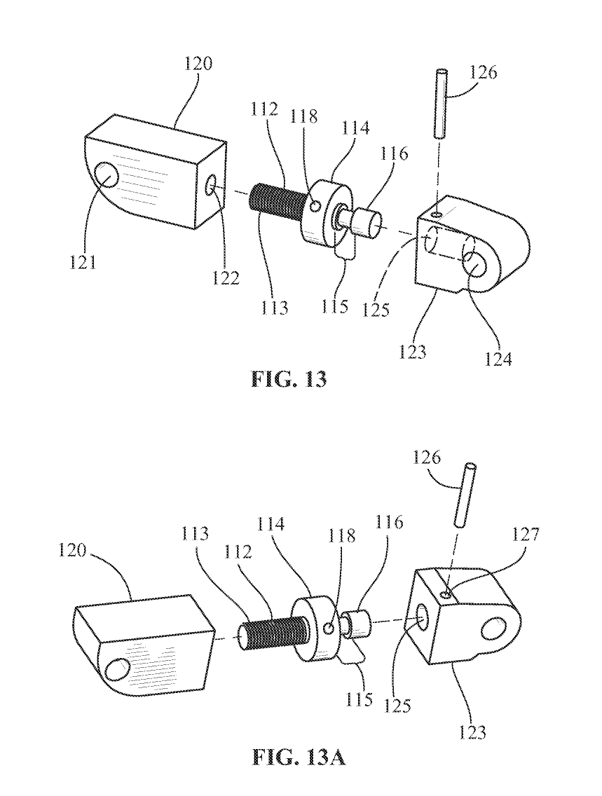

As collectively shown in FIGS. 1-3, an exemplary adjustable over-center locking pliers 10, shown in an open position 11, includes a stationary portion 12 in an operative connection 50, also referred to as an operative connection region, with a movable portion 18. As further shown in FIGS. 1-2, stationary portion 12 includes a first jaw segment 14 and first handle segment 16 with an operative connection region or operative connection 50 (openings 142, 144 of FIG. 3) positioned between first jaw segment 14 and first handle segment 16. As shown in FIGS. 1 and 3, movable portion 18 includes a second jaw segment 20 pivotably connected about a tool rotation axis 83 at one end (opening 154 of FIG. 3) to a corresponding opening 148 (FIG. 3) of a second handle segment 22. As further shown in FIGS. 1 and 3, an opening 121 of an adjustable linkage 110 (a mounting block 120 of FIG. 13) is pivotably connected about a tool rotation axis 85 to a corresponding opening 150 (FIG. 3) of second handle support 22. An opposed opening 124 (a mounting block 123 of FIG. 13) of adjustable linkage 110 is pivotably connected about a tool rotation axis 89 to a corresponding opening 144 (FIG. 3) of stationary portion 12. As further shown in FIGS. 1 and 3, an opening 156 of second jaw segment 20 is pivotably connected about a tool rotation axis 87 to opening 142 of stationary portion 12. Collectively, as shown in FIG. 1, pivotable connections about respective tool rotation axes 83, 85, 87, 89 (each axis shown in FIG. 1 as a point, as the axes extend into/out of the page) define operative connections 50 of the pliers. Fasteners 76, such as rivets, maintain the pivotable connections between the different pliers components of operative connections 50 about respective tool rotation axes 83, 85, 87, 89.

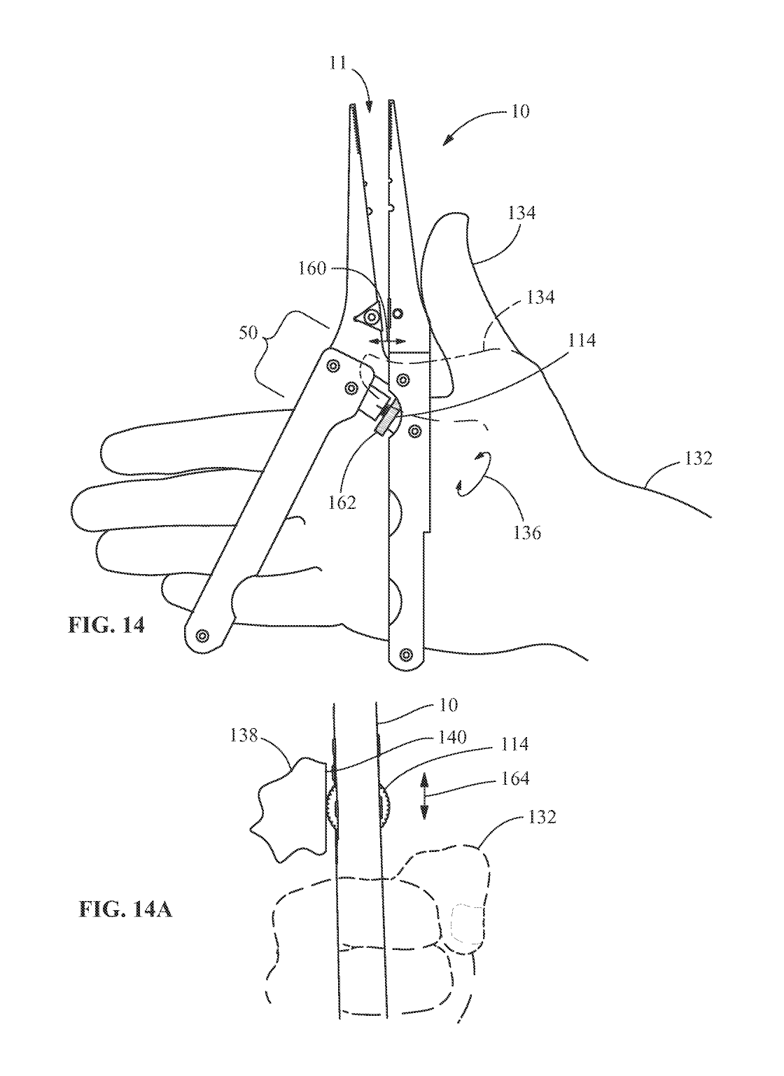

FIGS. 1-3, 13 and 13A show adjustable linkage 110 that permits adjustment to operative connection region or operative connection 50 (i.e., the adjustable linkage portion of the over-center locking pliers). As further shown in FIGS. 13 and 13A, adjustable linkage 110 includes an adjustment member 112 having a cylindrical body 114. As further shown in FIGS. 1-3, 13 and 13A, an adjustment feature 118, such as an opening is configured to receive a tool, such as needle 40 of needle assembly or tool 28 (FIG. 1) for imparting rotational movement about axis 158 (FIG. 3). In one embodiment, such as shown collectively in FIGS. 13 and 14, the diameter of cylindrical body 114 is enlarged and/or provided with gripping features 162 such as knurling or other suitable process otherwise enhancing the static coefficient of friction between a contacting surface, such as a surface 140 of an object 138 (FIG. 14) and gripping features 162 for imparting rotational movement about axis 158 (FIG. 3) of body 114 relative to mounting block 120. In another embodiment, gripping features 162 are contacted and engaged by a digit 134 of a hand 132 of an operator for imparting rotational movement about axis 158 (FIG. 3) of body 114 relative to mounting block 120.

As further shown in FIGS. 13 and 13A, extending from one end of body 114 of adjustable member 112 is a threaded portion 113 that is configured to be threadedly engaged with a mating threaded aperture 122 of mounting block 120. That is, rotational movement of body 114 relative to mounting block 120 results in a directional movement 160 (FIG. 3), in which the distance between body 114 and mounting block 120 is selectively increased or decreased, depending upon the direction of rotation. Extending from an opposite end of body 114 is a neck region 115, or a region of reduced cross-sectional area, that terminates in a head 116 having a greater cross sectional area than neck region 115. Head 116 is slidably received or otherwise directed inside of aperture 125 of mounting block 123. Upon sufficient insertion of head 116 inside of aperture 125, a retainer 126 is inserted into opening 127 of mounting block 123 for capturing head 116 inside of mounting block 123, while permitting relative rotational movement about axis 158 (FIG. 3). That is, while head 116 is permitted relative rotational movement about axis 158, head 116 is prevented from removal from inside of opening 125, or movement along a longitudinal axis 158 (FIG. 3) (other than the difference between the height of head 116 and the depth of aperture 125 as measured from retainer 126 to the bottom of aperture 125).

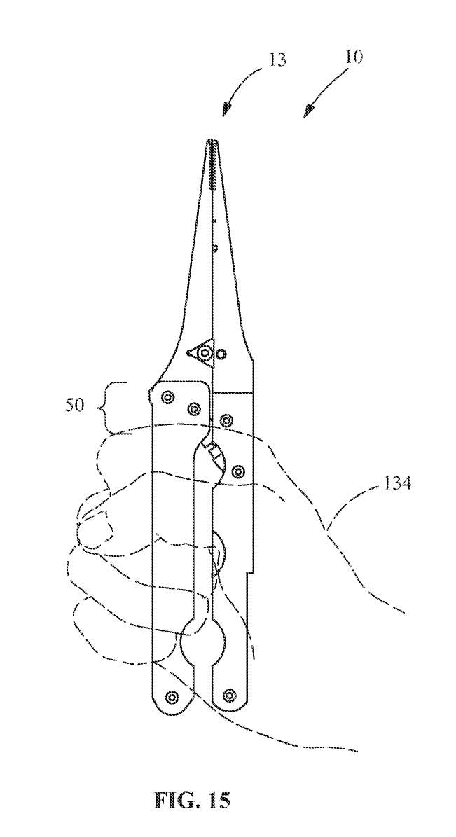

As a result of the above arrangement, adjustment of operative connection 50 or adjustment of the over-center locking pliers can be achieved, such as by changing the distance between tool rotation axes 85, 89 (FIG. 1). That is, with mounting blocks 120, 123 pivotably connected about respective tool rotation axes 85, 89 (FIG. 1) and thereby constrained from rotating about axis 158 (FIG. 3), imparting rotational movement of body 114 about axis 158 in one direction, such as by engaging adjustment feature 118 with needle 40 of tool 28 (FIG. 1) as previously discussed, results in a directional movement 160 (FIG. 3) of mounting block 120 away from body 114 (FIG. 13), thereby increasing the distance between openings 121, 124 of respective mounting blocks 120, 123, or increasing the length of adjustable linkage 110. Conversely, imparting rotational movement of body 114 in the other direction, such as by engaging adjustment feature 118 with needle 40 of tool 28 (FIG. 1) as previously discussed, results in a directional movement 160 (FIG. 3) of mounting block 120 toward body 114 (FIG. 13), thereby decreasing the distance between openings 121, 124 of respective mounting blocks 120, 123, or decreasing the length of adjustable linkage 110. As further shown in FIG. 14, instead of using needle 40 of tool 28 (FIG. 1) to engage adjustment feature 118 to impart rotational movement of body 114, with pliers 10 secured in an operator's hand 132, hand 132 results in rotational movement 136 of body 114. In one arrangement, such as further shown in FIG. 14, a digit 134, such as an operator's thumb, is brought into contact with gripping features 162 of body 114 and moved in a manner to impart rotational movement 136 of body 114. In another arrangement, with pliers 10 secured in an operator's hand 132, instead of bringing a digit 134 into contact with gripping features 162 of body 114, operator's hand 132 brings gripping features 162 of body 114 into sufficient contact (pressure) with surface 140 of object 138 (FIG. 14A) and guides pliers 10 in a directional movement 164 to impart rotational movement to body 114. It is to be understood that operator's hand 132 can be closed, such as depicted in FIG. 14A to surroundingly grip second handle segment 16 of stationary portion 12 (FIG. 1) in order to impart rotational movement to body 114, although alternately, the operator's hand 132 can be maintained similarly as shown in FIG. 14 in order to impart rotational movement to body 114. Other operator gripping arrangements are contemplated by the disclosure. The adjustment of the length of adjustable linkage 110 adjusts the amount of pressure jaw segments 14, 20 exert against each other when the pliers are brought together to a closed position 13 (FIG. 15). In a related manner, increasing the length of adjustable linkage 110 also increases the amount of closing force an operator must apply to handle segments 16, 22 to overcome the “dead center” position of the linkage of the locking pliers, in order to achieve the over-center position or closed position, as is well known to those having skill in the art. Therefore, a balance may be required between the desired clamping force applied by the operator and the ability of the operator to comfortably apply a sufficient closing force to handle segments 16, 22. However, in applications in which the desired clamping force is only required to adequately secure an object in a fixed position, such as a fish hook, such as for fly fishing, the forces necessary to close the pliers are small, and due to the considerable mechanical advantage (leverage) provided by handle segments 16, 22, should fall well within the grip strength of an operator.

As a result of the novel adjustable over-center locking pliers of the present disclosure (adjustable pivotable connections about respective tool rotation axes 83, 85, 87, 89 (FIG. 1) defining operative connections 50 of the pliers, between jaw segments 14, 20 and handle segments 16, 20), not only can the over-center locking linkage of the pliers be adjusted, as previously discussed, but with the additional space inside both handle segments 16, 22, that has not been previously available in conventional over-center locking pliers, tools previously required to be carried separately can now be incorporated into the pliers, creating a more fully equipped multi-purpose, adjustable over-center locking pliers.

For example, as shown in FIGS. 1-12, an exemplary embodiment of multi-purpose adjustable, over-center locking pliers, specially configured for fishing, and more specifically, fly fishing is now discussed. Pliers 10 have a number of tools pivotably connected to each of handle segments 16, 22. As further shown FIG. 1, first handle segment 16 includes tools 30, 32, 34, as well as a lanyard adapter 78, having an opening 80 for attaching a lanyard (not shown), to one or more of an operator or fishing reel for preventing inadvertent loss of the pliers (such as during use while standing in a stream), pivotably connected about tool rotation axis 86. As further shown FIG. 1, second handle segment 22 includes tools 24, 26, 28 pivotably connected about a tool rotation axis 88. Each of the tools is movable between an extended position 38 and a retracted position 36, such as shown for tool 34 (FIG. 2).

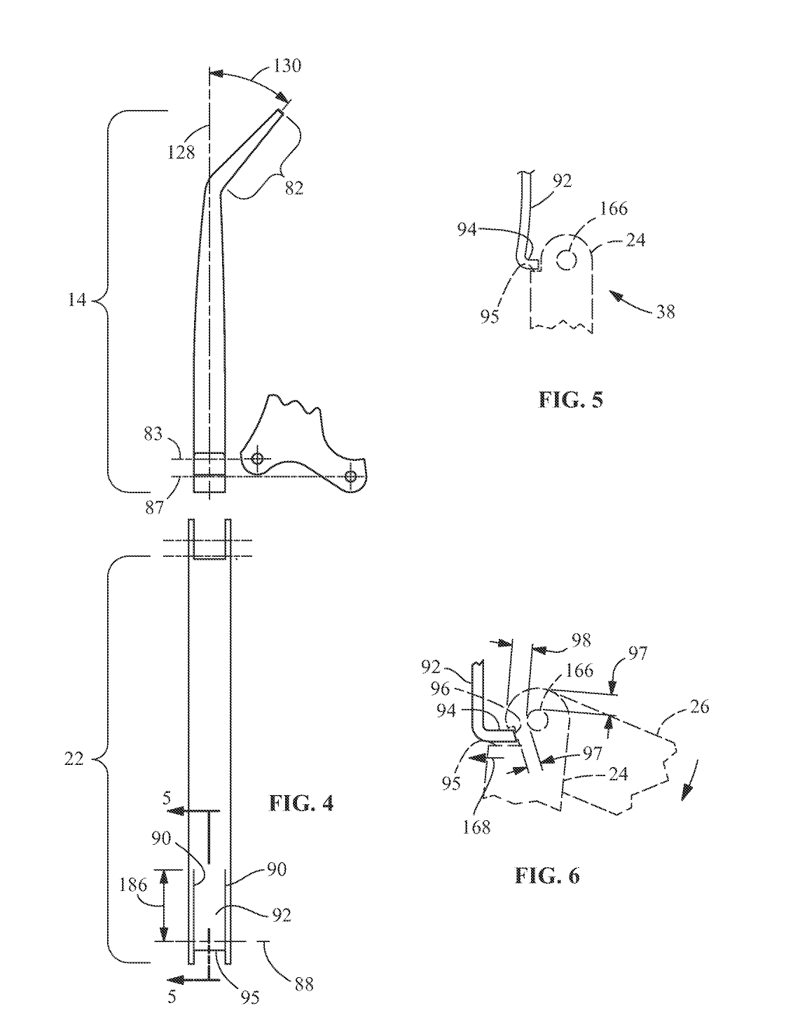

As shown in FIGS. 4, 5 and 6, all tools, with tool 24 identified for purposes of discussion and not intended to be limiting, have an opening 166 for receiving a fastener 76 (FIG. 1), such as a rivet, and a shoulder 95 that is supported in an extended position 38 as a result of a cantilevered tool lock/support 92 that extends to a lock tab 94 that abuts shoulder 95, preventing over-rotation of tool 24 when in extended position 38. In addition, all tools, such as tool 24 include an access feature 37 (FIG. 2), typically aligned with a tool access feature 102 (FIG. 1) formed in handle segments 16, 22 to permit each tool to be accessed from its recessed position 36 (FIG. 2) for rotation toward its extended position 38 (tool 34 is shown in recessed position 36 and extended position 38 in FIG. 2). Referring back to FIGS. 4, 5 and 6, tool lock/support 92 is formed near the end of each of handle segments 16, 22 (only second handle segment 22 is shown in FIG. 4) with slits 90 formed adjacent to the corners of the parallel walls 176 (FIG. 3) of the handle segments (such as for receiving openings 142, 144, 146, 148, 150, 152; FIG. 3), providing tool lock/support 92 with sufficient cantilevered length 186 (FIG. 4) to permit movement of tool lock/support 92 in a movement direction 168 (FIG. 6) as required to permit retraction of tool 24, especially when used with the tool stop geometry as shown in FIG. 6.

As shown in FIG. 6, tool 24 includes a locking feature 96, such as a recess is located in close proximity to lock tab 94. As further shown in FIG. 6, edge distances from opening 166 are different from each other to provide a locking feature of the tools when moved to extended position 38. That is, locking feature 96 corresponds to a material edge distance or edge distance 97 from opening 166, which edge distance 97 being less than an intermediate material edge distance or intermediate edge distance 98 representative of the tools in an intermediate position between retracted position 36 (FIG. 2) and extended position 38 (FIG. 2). As the tool approaches retracted position 36, the edge distance is reduced, such as to edge distance 97. As a result, when a first tool, such as tool 24 is placed in extended position 38, lock tab 94 of tool lock/support 92 engages locking feature 96, securing tool 24 in the extended position 38. In this arrangement, one technique to release tool 24 is to rotate another tool, such as tool 26 (not intended to be limiting), from retracted position 36 toward, but not achieving extended position 38. That is, as tool 26 approaches, but has not yet achieved extended position 38, the edge distance corresponding to tool 26 begins approaching larger dimension edge distance 98, which larger dimension edge distance 98 sufficiently deflects lock tab 94 of tool lock/support 92 in a movement direction 168, permitting disengagement of lock tab 94 from locking feature 96 of tool 24, thus permitting both tools 24, 26 to be rotated from extended position 38 to retracted position 36.

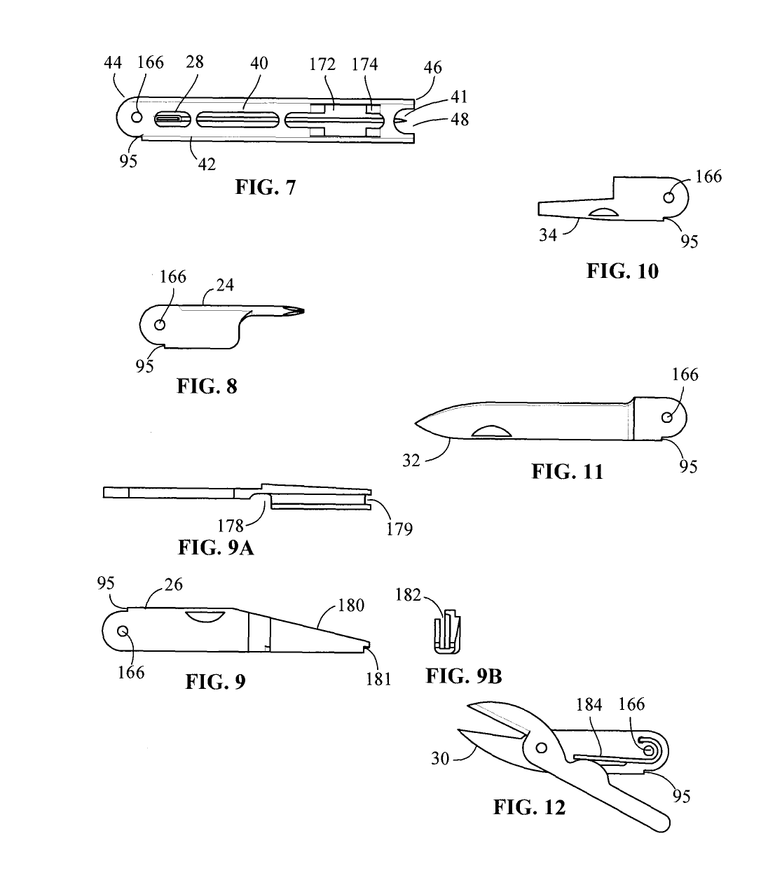

FIGS. 7-12 further describes the tools associated with the exemplary pliers. Tool 28 (FIG. 7) includes a needle 40 that is releasably insertable in a holder 42. A tip 41 of needle 40 is positioned within a notch 48 at a distal end 46 of holder 42 that is opposite a proximal end 44 which is in close proximity to shoulder 95 and pivotable opening 166 (FIG. 6) previously discussed and common to all pivotable tools. Tip 41 of needle 40 is usable to clean out or otherwise open an eyelet of a hook that can become sufficiently filled or “gummed up” with foreign matter such as dirt, rust, glue, paint, etc., or that is otherwise inaccessible. As shown in FIG. 7 in an installed position, tip 41 of needle 40 is sufficiently recessed in a notch 48 of holder 42 such that tip 41 can be used to open an eyelet 170 of hook 72 (FIG. 3), while generally protecting an operator from inadvertent contact with tip 41 of needle 40. Notch 48 of holder 42 may be utilized to help remove a hook from inside of the mouth of a freshly caught fish by insertion of tool 28 in extended position 38 (shown in FIG. 2 for tool 34) and a sufficient portion of the pliers inside of the mouth of the fish (not shown) to access the hook. More specifically, notch 48 would be positioned to contact a hook that is deeply embedded in mouth of the fish and application of a force relative to the fish in a direction opposite that of the hook barb 74 (FIG. 3), such that the hook barb 74 is disengaged from the fish. In addition, needle 40 may be usable as a “minnow rigging tool” that easily permits baiting of a hook with a minnow, in which needle 40 must be removed from holder 42. As further shown in FIG. 7, to assist in removing needle 40 from holder 42, an access region 172 is formed in holder 42, including a number of recessed portions 174, providing convenient manual access to needle 40 relative to holder 42, such as by opposed digits of an operator (not shown).

Tool 24 (FIG. 8) is a Phillips head screwdriver, such as a No. 1 Phillips head, that is usable to tighten loose Phillips head fasteners, such as used with many fly reels.

Tool 26 (FIGS. 9, 9A and 9B) is a knotting tool having numerous knotting manipulation features, such as knotting manipulation features 178, 179, 180, 181, 182, more prominently including a ramp 180 and threading channel 182. Using these knotting manipulation features permits an operator to more easily form knots, including complicated knots, such as often used to re-tie the tippet and leader line for fly fishing. Several of the knots that can be more easily formed or tied using knotting tool 26 include, but are not limited to nail knots, cinches, improved cinches, surgeon's loops and blood knots.

Tool 34 (FIG. 10) is a flat head screwdriver, such as a No. 1 flat head, that is usable to tighten loose flat head fasteners, such as used with many fly reels.

Tool 32 (FIG. 11) is a blade usable for many application, such as field dressing caught fish, cutting bait, etc.

Tool 30 (FIG. 12) is a nipping scissors having a pair of pivoting cutting portions, as well as a spring 184 for urging the cutting portions away from each other. Tool 30 is usable, among many applications, including cutting line, trimming hackle hair of a fishing lure, etc.

It is to be understood that a number of tools used with the pliers can be different than those shown in the figures, if desired, and/or if the pliers is directed for primary use in any number of different applications.

FIG. 3 shows a sharpening tool 52 that is integrally connected to the pliers. In one embodiment, sharpening tool 52 is a diamond sharpening tool that typically includes an outer layer of micron-sized diamonds bonded to a backing surface, such as a metal surface. As further shown in FIG. 3, sharpening tool 52 includes a pair of openings 57, since as countersunk openings for receiving a corresponding pair of mating countersunk head fasteners 55 that are threadedly engaged with the pliers, such as with first handle segment 16 as shown in FIG. 1. However, for purposes herein, the term integrally connected is intended to include any arrangement or construction in which the sharpening tool is secured to the pliers, including fasteners, welding, adhesives, direct or indirect application of an abrasive coating layer to a portion of the pliers, or the like. As further shown in FIG. 3, sharpening tool 52 includes a pair of grooves 54, 56, such as parallel grooves formed therein, such as along opposed sides of sharpening tool 52. In one embodiment, each of grooves 54, 56 is configured to correspond to one of opposed fishing hook barbed surfaces 73, 75. That is, for example, groove 54 is configured to correspond to one or more outer fishing hook barbed surface(s) 73, and groove 56 is configured to correspond to one or more inner fishing hook barbed surface(s) 75. Previously, sharpening tools were separate tools, and not conveniently available for use while actively fishing, e.g., to help straighten/sharpen a hook barbed end/surface after striking a rock after casting, thereby greatly improving the opportunity for successfully catching fish. It is to be understood that a different number than two grooves may be formed in sharpening tool 52, and that sharpening tool 52 may be integrally connected to one or more different portions of the pliers, if desired, such as jaw segments 14, 20 or pivotably connected in a manner similar to tools 24-34.

In summary, in one exemplary embodiment, such as shown in FIG. 1, the pliers of the present disclosure provide a single multi-purpose pliers having tools believed to be especially useful for fishing, and more specifically, fly fishing.

FIGS. 1-3 collectively shows first and second jaw segments 14, 20 each having corresponding portions of a cutting region 58, a crimping region 66, and a gripping region 82. Although conventional cutting regions 58 can include sharpened edge portions formed in the corresponding portions of the jaw segments of the pliers, such an arrangement may not be optimal, in that the material of the jaw segments may be optimized for strength and/or corrosion resistance, such as a stainless steel alloy, which may not have optimized properties for cutting surfaces, such as hardness. Therefore, each cutting region 58, as shown in FIGS. 1-3, includes a recess 62 having a threaded aperture 64 formed in corresponding portions of first and second jaw segment 14, 20 for each receiving corresponding inserts 60. In one embodiment, inserts 60 are composed of carbide or other suitable material. Respective threaded fasteners 65 threadedly engage corresponding threaded apertures 64 in order to secure inserts 60 in mutual alignment for purposes of cutting objects inserted between the inserts in cutting region 58. Inserts 60 are shown having three cutting surfaces that can be positioned for use as required to provide the pliers with an enhanced cutting region that can be maintained for an extended period of time. Further, upon all cutting surfaces of inserts 60 being diminished through use, replacement inserts 60 may be used as required, without the need to replace the pliers. It is to be understood that the inserts can have a number of cutting surfaces different than three cutting surface. In one embodiment one insert can include cutting surfaces, in another insert can include an anvil for abutting the cutting surface. In another embodiment, only one insert may be required.

As further collectively shown in FIGS. 1-3, jaw segments 14, 20 includes a crimping region 66. Crimping region 66 includes one or more recesses, such as recesses 68, 70 and corresponding, respective protrusions, such as protrusions 69, 71. Combinations of recesses 68, 70 and respective protrusions 69, 71 are sized differently from each other in order to accommodate differently sized objects, such as lead weights for fishing applications, crimping terminals such as for securing a plurality of electrical conductors together, and the like.

As further shown collectively in FIGS. 1 and 4, jaw segments 14, 20 include a gripping region 82 including gripping features such as teeth 84 for grippingly engaging an object positioned therebetween. As further shown in FIGS. 1 and 4, jaw segments 14, 20 have a narrowing taper toward the distal tips of gripping region 82, also referred to as a “needle nose” construction. Additionally, as further shown in FIG. 4, gripping region 82 includes an angular offset 130 from a center plane 128, or a plane that extends substantially through a central portion of the jaw segments. In one embodiment, angular offset 130 subtends an acute angle from center plane 128. One application for which both the tapered or “needle nose” and angular offset 130 features are especially beneficial is for hook removal during fishing. That is, both features enhance the ability of an operator to perceive, engage and manipulate (remove) the hook from the confined space within the mouth of a fish, while minimizing trauma to the fish.

While the pliers may be composed of stainless steel or an alloy thereof, for reasons including corrosion resistance, strength and appearance, it is to be understood that the pliers, or at least different components of the pliers may be composed of different materials, as desired, and/or as guided by application/environment.

It is also to be understood that other tools that can be pivotably connected in a manner similar to that disclosed in the present disclosure may be substituted and/or supplemented as desired.

It is to be understood that while an exemplary embodiment of the pliers includes each of cutting regions crimping regions, gripping regions, tapered jaw segments having an angular offset, in another embodiment, the pliers can include one or any combination of these features/regions.

While only certain features and embodiments of the invention have been shown and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

What is claimed is:

1. An adjustable over-center locking pliers comprising:
a stationary portion having a first jaw segment and a first handle segment;
a movable portion having a second jaw segment and a second handle segment operatively connected to the stationary portion between the jaw segments and the handle segments; and
at least one tool movable between a first position and a second position;
wherein the stationary portion movably secures the at least one tool in the first position in the first handle segment of the stationary portion.

2. The pliers of claim 1, wherein the first handle segment receives the at least one tool in the first position substantially inside of the first handle segment.

3. The pliers of claim 1, wherein the at least one tool is pivotably connected to the first handle segment.

4. The pliers of claim 1, wherein the at least one tool includes a needle removably mounted in a holder having proximal and distal ends.

5. The pliers of claim 4, wherein the distal end of the holder includes a notch.

6. The pliers of claim 1, wherein the at least one tool includes a knotting tool.

7. The pliers of claim 1, comprising a sharpening tool integrally connected to the pliers.

8. The pliers of claim 7, wherein the sharpening tool having at least one groove formed therein, the groove corresponding to one of opposed fishing hook barbed surfaces.

9. The pliers of claim 1, wherein the jaw segments form a cutting region therebetween.

10. The pliers of claim 9, wherein the cutting region includes at least one insert receivable in a recess formed in at least one of the jaw segments.

11. The pliers of claim 1, wherein the jaw segments form a crimping region therebetween.

12. The pliers of claim 1, wherein the jaw segments include a gripping region.

13. The pliers of claim 12, wherein the gripping region of the jaw segments are angularly offset from the remaining portion of the jaw segments.

14. The pliers of claim 13, wherein the angular offset of the gripping region of the jaw segments forms an acute angle relative to the remaining portion of the jaw segments.

15. An adjustable over-center locking pliers comprising:
a stationary portion having a first jaw segment and a first handle segment; and
a movable portion having a second jaw segment and a second handle segment operatively connected to the stationary portion between the jaw segments and the handle segments.

16. The pliers of claim 15, wherein the operative connection is adjustable.

17. The pliers of claim 16, wherein the operative connection is manually adjustable by an operator using one hand.

18. The pliers claim 17, wherein the operative connection is manually adjustable by an operator using one hand, while the pliers remain positioned in the one hand of the operator.

19. A method for adjusting over-center locking pliers comprising:
providing a stationary portion having a first jaw segment and a first handle segment, and a movable portion having a second jaw segment and a second handle segment operatively connected to the stationary portion between the jaw segments and the handle segments, the pliers movable between an open position and a closed position;
manipulating the pliers to the open position;
while securing the pliers in one hand, the one hand resulting in adjustment of the manually adjustable operative connection.

20. The method of claim 19, wherein while securing the pliers in one hand, the same hand achieving rotation of a portion of the manually adjustable operative connection using at least one digit of the one hand.

21. The method of claim 19, subsequent to the one hand resulting in adjustment of the manually adjustable operative connection, comprising the same hand selectively manipulating the pliers toward the closed position.
